(19) United States
(12) Patent Application Publication
(10) Pub. No.: US 2025/0061146 A1
(43) Pub. Date: Feb. 20, 2025

(54) IMAGE QUERY PROCESSING USING LARGE LANGUAGE MODELS

(71) Applicant: GOOGLE LLC, Mountain View, CA (US)

(72) Inventors: Olivier Siegenthaler, Zurich (CH); Ágoston Weisz, Zurich (CH); Boris Bluntschli, Zurich (CH); Dan Banica, Zurich (CH); Kaan Ege Özgün, Zurich (CH); Daniel Mogoreanu, Zurich (CH); Filip Sladek, Zurich (CH)

(21) Appl. No.: 18/802,734

(22) Filed: Aug. 13, 2024

Related U.S. Application Data
(60) Provisional application No. 63/532,543, filed on Aug. 14, 2023.

(51) Int. Cl. G06F 16/532; G06F 40/40; G06V 10/80; G06V 20/50

(52) U.S. Cl. CPC G06F 16/532; G06F 40/40; G06V 10/803; G06V 20/50

(57) ABSTRACT

Implementations utilize an LLM to respond to queries comprising image data, such as multimodal queries that include both text and image data. A natural language processing system is extended such that when an image is provided, the natural language processing system invokes one or more auxiliary image processing models (e.g., visual query) and/or image search engines. The results, of invoking such model(s) and/or search engine(s), are collected into structured data signals related to the image. These signals form part of the conversation context and are used to extend the text prompt that is sent to the LLM. This allows the LLM to take the context into account when being used to process the user query, thereby enabling generation of an LLM reply that addresses relevant feature(s) of the image.

### BACKGROUND

Various generative models have been proposed that can be used to process natural language (NL) content and/or other input(s), to generate output that reflects generative content that is responsive to the input(s). For example, large language models (LLM(s)) have been developed that can be used to process NL content and/or other input(s), to generate LLM output that reflects NL content and/or other content that is responsive to the input(s). For instance, an LLM can be used to process NL content of “how to change DNS settings on Acme router”, to generate LLM output that reflects several responsive NL sentences such as: “First, type the router's IP address in a browser, the default IP address is 192.168.1.1. Then enter username and password, the defaults are admin and admin. Finally, select the advanced settings tab and find the DNS settings section”. However, current utilizations of generative models suffer from one or more drawbacks.

As one example, LLMs can be utilized as part of a text-based dialogue application, generating responses to textual inputs/queries provided by a user of the application. However, LLMs can are limited to accepting a set of tokens provided in sequence (e.g., text) as input. A user of the application may have queries relating to one or more images. These queries cannot be addressed by the LLM directly due to the limit of input types accepted by the LLM.

### SUMMARY

Implementations disclosed herein are directed to at least utilizing an LLM to respond to queries comprising image data, such as multimodal queries that include both text and image data. A natural language processing system is extended such that when an image is provided as part of the conversation with a chatbot, the natural language processing system invokes one or more auxiliary image processing models (e.g., visual query) and/or image search engines. The results of invoking these models/searches are collected into structured data signals related to the image. These signals form part of the conversation context and are used to extend the text prompt that is sent to the LLM. This allows the LLM to take the context into account when it is utilized in processing the user query, thereby enabling generation of an LLM reply that addresses relevant feature(s) of the image. Accordingly, the LLM is utilized to generate a response that takes the image into account.

In these, and other, manners, an LLM can act as a flexible image classification and/or image querying model without necessitating specialized multi-modal training or architectural adaptations. Furthermore, text-based dialogue applications can be extended to integrate images that the user provides, providing the application with the ability to analyze the image, reason about it, and answer specific questions about images along the flow of a conversation.

In some implementations, an LLM can include at least hundreds of millions of parameters. In some of those implementations, the LLM includes at least billions of parameters, such as one hundred billion or more parameters. In some additional or alternative implementations, an LLM is a sequence-to-sequence model, is Transformer-based, and/or can include an encoder and/or a decoder. One non-limiting example of an LLM is GOOGLE'S Pathways Language Model (PaLM). Another non-limiting example of an LLM is GOOGLE'S Language Model for Dialogue Applications (LaMDA). However, and as noted, it should be noted that the LLMs described herein are one example of generative machine learning models are not intended to be limiting.

The preceding is presented as an overview of only some implementations disclosed herein. These and other implementations are disclosed in additional detail herein.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2 depicts an overview of an example method for responding to multimodal query.

FIG. 3 illustrates an overview of an example method for responding to an image query.

FIG. 4 depicts a flowchart that illustrates an example method of responding to a multimodal query.

FIG. 5 depicts a flowchart that illustrates an example method of responding to an image-based query.

FIG. 6 depicts an example architecture of a computing device, in accordance with various implementations.

### DETAILED DESCRIPTION

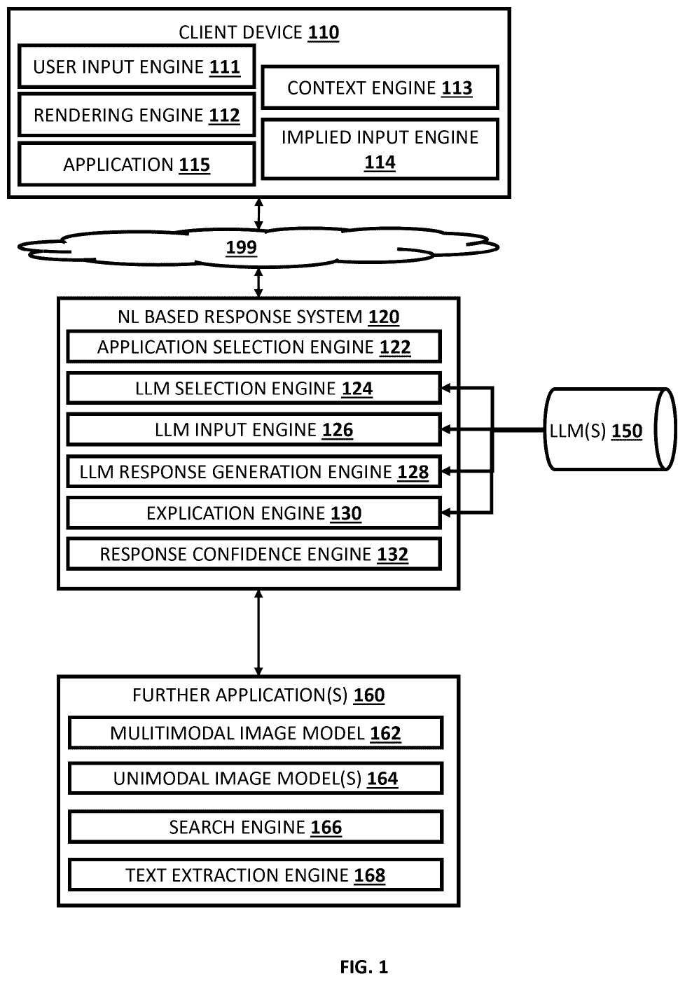

Turning now to FIG. 1, a block diagram of an example environment 100 that demonstrates various aspects of the present disclosure, and in which implementations disclosed herein can be implemented is depicted. The example environment 100 includes a client device 110, a natural language (NL) based response system 120, and one or more further applications 160 (i.e. applications external to an LLM or a dialogue application executed on the client device 110). Although illustrated separately, in some implementations all or aspects of NL based response system 120 and all or aspects of the one or more further applications 160 can be implemented as part of a cohesive system.

In some implementations, all or aspects of the NL based response system 120 can be implemented locally at the client device 110. In additional or alternative implementations, all or aspects of the NL based response system 120 can be implemented remotely from the client device 110 as depicted in FIG. 1 (e.g., at remote server(s)). In those implementations, the client device 110 and the NL based response system 120 can be communicatively coupled with each other via one or more networks 199, such as one or more wired or wireless local area networks (“LANs,” including Wi-Fi LANs, mesh networks, Bluetooth, near-field communication, etc.) or wide area networks (“WANs”, including the Internet).

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

The client device 110 can execute one or more applications, such as application 115, via which queries can be submitted and/or NL based summaries and/or other response(s) to the query can be rendered (e.g., audibly and/or visually). The application 115 can be an application that is separate from an operating system of the client device 110 (e.g., one installed “on top” of the operating system)—or can alternatively be implemented directly by the operating system of the client device 110. For example, the application 115 can be a web browser installed on top of the operating system, or can be an application that is integrated as part of the operating system functionality. The application 115 can interact with the NL based response system 120.

In various implementations, the client device 110 can include a user input engine 111 that is configured to detect user input provided by a user of the client device 110 using one or more user interface input devices. For example, the client device 110 can be equipped with one or more microphones that capture audio data, such as audio data corresponding to spoken utterances of the user or other sounds in an environment of the client device 110. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to touch input directed to the client device 110. Some instances of a query described herein can be a query that is formulated based on user input provided by a user of the client device 110 and detected via user input engine 111. For example, the query can be a typed query that is typed via a physical or virtual keyboard, a suggested query that is selected via a touch screen or a mouse, a spoken voice query that is detected via microphone(s) of the client device, or an image query that is based on an image captured by a vision component of the client device.

In various implementations, the client device 110 can include a rendering engine 112 that is configured to provide content (e.g., an NL based summary) for audible and/or visual presentation to a user of the client device 110 using one or more user interface output devices. For example, the client device 110 can be equipped with one or more speakers that enable content to be provided for audible presentation to the user via the client device 110. Additionally, or alternatively, the client device 110 can be equipped with a display or projector that enables content to be provided for visual presentation to the user via the client device 110.

In various implementations, the client device 110 can include a context engine 113 that is configured to determine a context (e.g., current or recent context) of the client device 110 and/or of a user of the client device 110. In some of those implementations, the context engine 113 can determine a context utilizing current or recent interaction(s) via the client device 110, a location of the client device 110, profile data of a profile of a user of the client device 110 (e.g., an active user when multiple profiles are associated with the client device 110), and/or other data accessible to the context engine 113. For example, the context engine 113 can determine a current context based on a current state of a query session (e.g., considering one or more recent queries of the query session), profile data, and/or a current location of the client device 110. For instance, the context engine 113 can determine a current context of “looking for a healthy lunch restaurant in Louisville, Kentucky” based on a recently issued query, profile data, and a location of the client device 110. As another example, the context engine 113 can determine a current context based on which application is active in the foreground of the client device 110, a current or recent state of the active application, and/or content currently or recently rendered by the active application. A context determined by the context engine 113 can be utilized, for example, in supplementing or rewriting a query that is formulated based on user input, in generating an implied query (e.g., a query formulated independent of user input), and/or in determining to submit an implied query and/or to render result(s) (e.g., an NL based summary) for an implied query.

In various implementations, the client device 110 can include an implied input engine 114 that is configured to: generate an implied query independent of any user input directed to formulating the implied query; to submit an implied query, optionally independent of any user input that requests submission of the implied query; and/or to cause rendering of result(s) for an implied query, optionally independent of any user input that requests rendering of the result(s)). For example, the implied input engine 114 can use current context, from context engine 113, in generating an implied query, determining to submit the implied query, and/or in determining to cause rendering of result(s) for the implied query. For instance, the implied input engine 114 can automatically generate and automatically submit an implied query based on the current context. Further, the implied input engine 114 can automatically push result(s) to the implied query to cause them to be automatically rendered or can automatically push a notification of the result(s), such as a selectable notification that, when selected, causes rendering of the result(s). As another example, the implied input engine 114 can generate an implied query based on profile data (e.g., an implied query related to an interest of a user), submit the query at regular or non-regular intervals, and cause corresponding result(s) for the submission(s) to be automatically provided (or a notification thereof automatically provided). For instance, the implied query can be “patent news” based on profile data indicating interest in patents, the implied query periodically submitted, and a corresponding NL based summary result automatically rendered. It is noted that the provided NL based summary result can vary over time in view of e.g., presence of new/fresh search result document(s) over time.

Further, the client device 110 and/or the NL based response system 120 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device having a single user, it should be understood that is for the sake of example and is not meant to be limiting. For example, one or more additional client devices of a user and/or of additional user(s) can also implement the techniques described herein. For instance, the client device 110, the one or more additional client devices, and/or any other computing devices of a user can form an ecosystem of devices that can employ techniques described herein. These additional client devices and/or computing devices may be in communication with the client device 110 (e.g., over the network(s) 199). As another example, a given client device can be utilized by multiple users in a shared setting (e.g., a group of users, a household).

NL based response system 120 is illustrated as including an application selection engine 122, an LLM selection engine 124, an LLM input engine 126, an LLM response generation engine 128, an explication engine 130, a response confidence engine 132, and an interaction engine 134. Some of the engines can be omitted in various implementations.

The application selection engine 122 can, in response to receiving a query, determine one or more external applications 160 to invoke. The application selection engine 122 can select applications that are relevant to the query, e.g. determine that the input query comprises an image, and select/invoke one or more image processing application in response.

The LLM selection engine 124 can, in response to receiving a query, determine which, if any, of multiple generative model(s) (LLM(s) and/or other generative model(s)) to utilize in generating response(s) to render responsive to the query. For example, the LLM selection engine 124 can select none, one, or multiple generative model(s) to utilize in generating response(s) to render responsive to a query. The LLM selection engine 124 can optionally utilize one or more classifiers and/or rules (not illustrated).

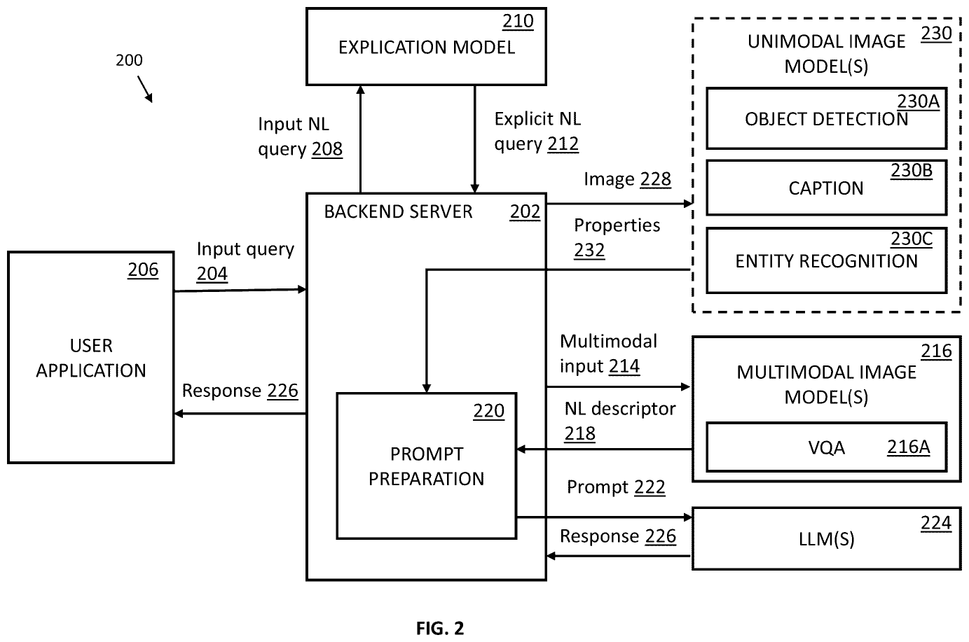

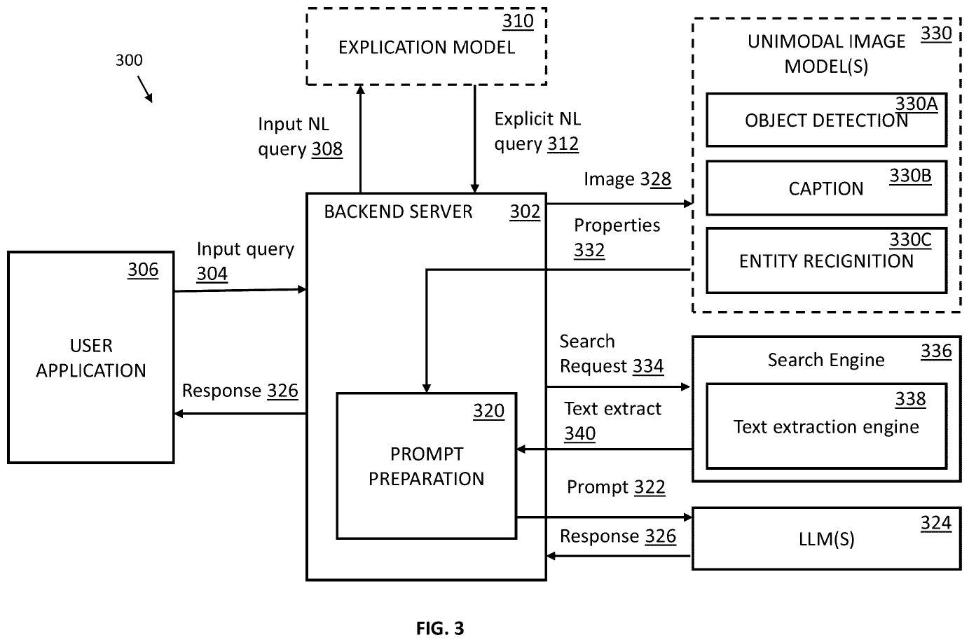

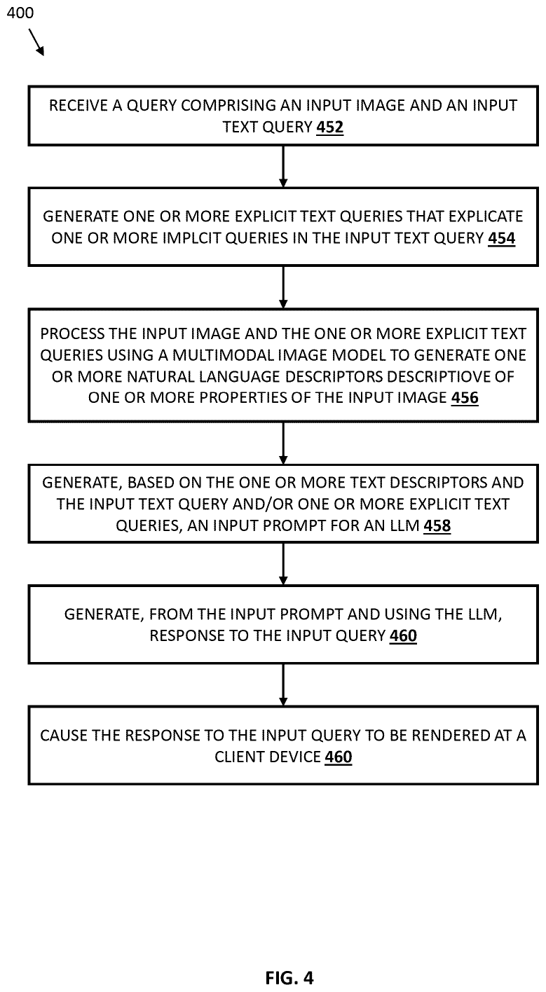

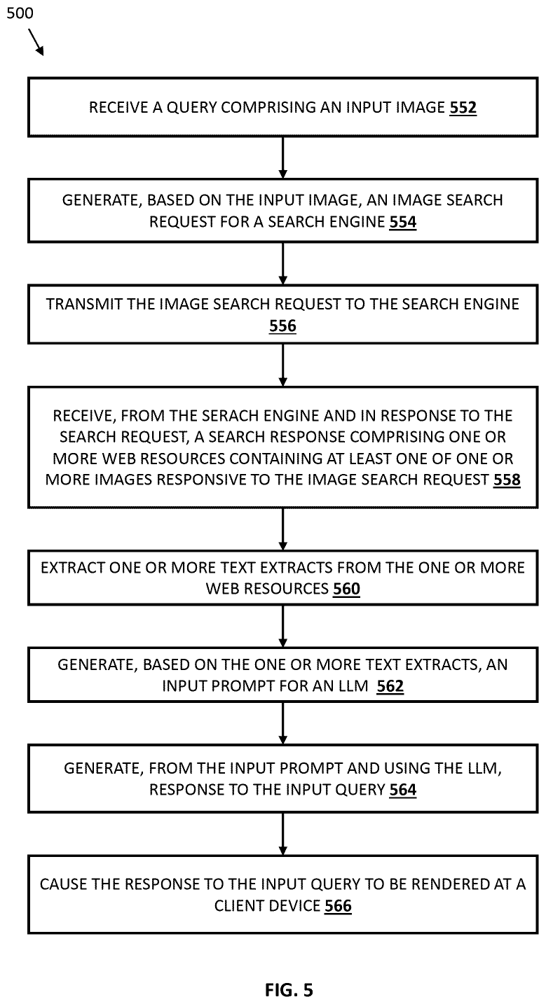

The LLM input engine 126 can, in response to receiving a query, generate LLM input that is to be processed using an LLM in generating an NL based response to the query. As described herein, such content can include query content that is based on the query and/or additional content, such as contextual information derived from the one or more further applications 160. In various implementations, the LLM input engine 126 can perform all or aspects of the prompt engine 220, 320 of FIG. 2 and FIG. 3, aspects of blocks 458 of method 400 of FIG. 4, and/or aspects of block 562 of FIG. 5, etc.

The LLM response generation engine 128 can process LLM input, that is generated by the LLM input engine 126, using an LLM to generate an NL based response. In various implementations, the LLM response generation engine 128 can perform all or aspects of the LLM(s) 224. 324 of FIG. 2 and FIG. 3, block 460 of method 400 of FIG. 4, and/or block 564 of method 500 of FIG. 5. The LLM response generation engine 128 can utilize one or more LLMs 150.

The explication engine 138 explicate one or more implicit queries in the received query, for example based on a conversation history. In various implementations, the explication engine 130 can perform all or aspects of the explication model 210, 310 of FIG. 2 and/or FIG. 3, and/or block 454 of FIG. 4. The explication engine 130 can utilize one or more LLMs 150.

The response confidence engine 132 can determine confidence measures for portions of a generated NL based response and/or for a generated NL based response as a whole.

The set of external applications 160 is illustrated as including one or more multimodal image processing models 162, one or more unimodal image processing models 164, one or more search engines 166 and one or more text extraction engines 168. Some of the engines can be omitted in various implementations.

The one or more multimodal image processing models 162 can process image and text input, e.g. explicated text queries, to generate natural language descriptors of properties/contents of the image that are responsive to the text input. In various implementations, the one or more multimodal image processing models 162 can perform all or aspects of the multimodal models 216 of FIG. 2, and/or block 456 of FIG. 4.

The one or more unimodal image processing models 164 can process image input to determine one or more properties of the input that are independent of any input text query. In various implementations, the one or more unimodal image processing models 164 can perform all or aspects of the unimodal models 230, 330 of FIG. 2 and/or FIG. 3.

The one or more search engines 166 can perform image searches, e.g. reverse image searches, based on an image search request generated from an input image. The one or more search engines 166 return one or more web resources (e.g. webpages) that contain at least one of one or more images responsive to the image search. In various implementations, the one or more search engines 166 can perform all or aspects of the search engines 336 of FIG. 3, and/or blocks 556 and/or 558 of FIG. 5.

The text extraction engine 168 can extract text from the one or more web resources returned by the one or more search engines 166 in response to the image search. In various implementations, the text extraction engine 168 can perform all or aspects of the text extraction engine 338 of FIG. 3, and/or block 560 of FIG. 5.

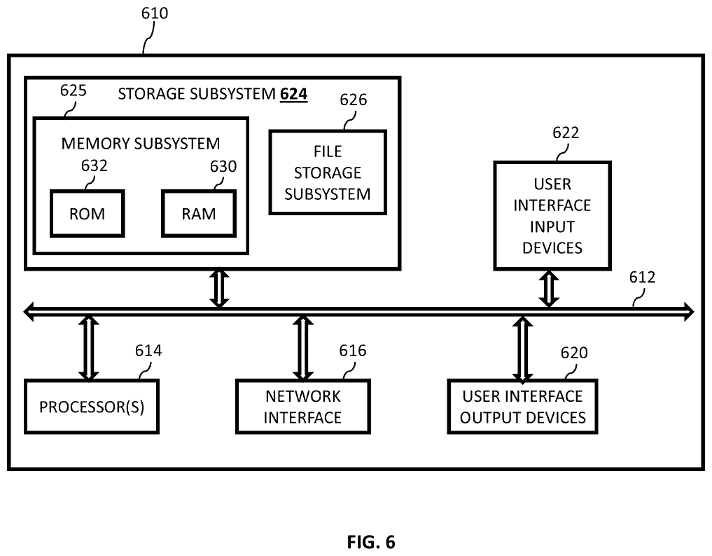

Turning now to FIG. 2, FIG. 2 illustrates an overview of an example method for responding to multimodal query. The method may be performed by one or more computer systems, such as the system described herein in relation to FIG. 6.

A computer system, such as a backend server 202 (such as the NL based response system 120 described herein in relation to FIG. 1), receives an input query 204 comprising an input image and an input natural language query that refers to the input image (either explicitly or implicitly) from a user application 206 running on a client device (such as client device 110 described herein in relation to FIG. 1). The natural language query 208 is processed by an explication engine 210, which converts implicit queries in the natural language query into one or more explicit natural language queries 212. The one or more explicit natural language queries 212 and the input image are used as a multimodal input 214 input into one or more multi-modal image processing models 216, such as a visual query answering model 216A (VQA), which processes them to generate one or more natural language descriptors 218 of properties of the input image that are responsive to the one or more explicit queries. The one or more natural language descriptors 218 are used by a prompt generation engine 220 to generate one or more prompts 222 for one or more LLMs 224. The one or more LLMs 224 (also referred to herein a “conversation LLMs”) process the generated prompts 222 to generate one or more responses 226 to the input query 204. One or more of the responses 226 are output to a user via the user application 206 on the client device.

The input natural language query 208 is, in some examples, received in the form of an input text query. The input text query 208 can, for example, originate as text input manually by a user of the user application 206. Alternatively or additionally, the input text query 208 can originate from a spoken input to the user application 206, e.g. a spoken query input after invoking the user application 206. The spoken input is converted to the input text query by a speech-to-text engine running on the client device (either as part of the user application 206, or accessible by the user application 206).

The input text query 208 refers to the input image, either explicitly or implicitly. The input text query 208 may also refer to one or more objects in the input image, either explicitly or implicitly. For example, an explicit text query is “what are the contents of the toolbox in this image?”. This query refers to both the input image (“this image”) and an object (“the toolbox”) in the image explicitly. An example of an implicit text query is “what is in it?”. This query refers to the image and an object in the image (“it”) implicitly, e.g. by virtue of being submitted with the input image. In some examples, an input text query contains both implicit and explicit references to the image and/or one or more objects in the image. For example,

The input text query is, in some examples, part of an ongoing human-computer dialogue, e.g. a sequence of input queries (with or without corresponding input images) and their corresponding responses from the NL based response system. For example, a first input query comprises an image of a toolbox and a text query “What is in the image?”. The NL based response system generates a response (e.g. using any of the methods described herein) and responds with “A toolbox”. A further text query, “What is in it?”, is received from the user.

The explication engine 210 acts to explicate implicit queries in the input text query 208 so that they can be utilized with multimodal image processing models, which typically cannot handle implicit queries. The explication engine 210 is, in some examples, an LLM. In some examples, the LLM is a specialized explication LLM, i.e., trained specifically for explication. Alternatively, the LLM is a more general LLM, and may, in some examples be one or more of the conversation LLMs 224. Other types of language processing model may alternatively be used.

In some implementations, the explication engine 210 is further provided with a representation of a dialogue history. For example, the previous text queries, input as part of a current dialogue session and prior to the current text query, and their respective responses are input into the explication engine 210 as context. For example, following the example of the toolbox, the explication engine receives the current text query “What is in it?”, and the previous query and response “what is this?”, “It is a toolbox”. The explication of the current text query in this example could be, e.g., “What tools are in the toolbox?”.

In examples where the explication engine 210 comprises one or more LLMs, the input to the explication model may be a prompt requesting that a conversation is rephrased into a one or more explicit question/queries. For example, the input prompt may be “Here is a short conversation. Rephrase it into a single question”, followed by the conversation history up to the current input query, e.g. “what is this?”, “it is a toolbox”, “what is in it?”.

Multimodal input 214 comprising the one or more explicit text queries 212 and the input image is input into one or more multimodal image processing models 216 (also referred to herein as “multimodal image models”), such as one or more VQA models 216A. VQA (Visual Question Answering) models are multimodal image models that can answer targeted questions on an input image. Typically, VQA models are stateless and cannot perform complex reasoning tasks. Providing explicit queries to a VQA model 216A assists the VQA model 216A in extracting relevant information from the input image.

The one or more multimodal image models 216 process the multimodal input and return natural language descriptors 218 of properties of the image that are responsive to the one or more explicit natural language queries 212, i.e. that are relevant to and/or address the explicit query. Returning to the example of a toolbox, the multimodal image models 216 receive the input image and the explicit query “What tools are in the toolbox?”. The one or more multimodal image models 216 process this multimodal input 214 to generate the natural language descriptor “a wrench and a spanner”.

The prompt engine 220 receives the input comprising the natural language descriptors 218 output by the multimodal image processing models 216, and the input text query 208 and/or the explicit text query 212. The input is processed by the prompt engine 220 to generate a natural language prompt 222 for an LLM 224 that includes contextual information relating to the input image. Such a prompt allows the LLM 224 to generate a response to the input query 204 that takes into account features/properties of the input image.

In some examples, the prompt generation engine 220 transforms the natural language descriptors into a text prompt using a static schema. For example, the prompt generation engine 220 generates a text prompt by performing operations that comprise appending the natural language descriptors 218 to respective predefined natural language strings and/or filling one or more slots in respective predefined natural language strings, i.e. natural language strings that describe the output of the multimodal model. The full text prompt 222 further comprises the input text query 208 and/or the explicit text query 212. In some implementations, the full text prompt 222 is enriched with the conversation history, e.g. a full history of the inputs and response of a current dialogue, or a natural language summary of the current dialogue. In some implementations, the full prompt 222 further includes one or more instructions to the LLM, e.g., “Please reply in a polite and helpful manner.”

Taking the example of the toolbox, an example prompt 222 generated by the prompt generation engine 220 is:
“Please reply in a polite and helpful manner.
Context: [VQA] a wrench and a spanner
Context: [History] What is it?
Context: [History] It is a toolbox
Query: What is in the toolbox?”

In some implementations, one or more unimodal image models 230 are used to determine one or more query independent properties 232 of the input image 228, i.e. properties of the image that are agnostic to the input text query. The query independent properties 332 are, in some examples, input into the prompt generation engine 220 in addition to the text query 208, 212 and the natural language descriptors 218 output by the multimodal image models 216, and used to generate the prompt 222 for the one or more LLMs 224. The prompt generation engine 220 uses, in some implementations, a static schema to convert the unimodal image model output 232 into part of the prompt 222 in a similar manner to that described herein with respect to the prompt generation engine 220.

The one or more unimodal image models 228 comprise, in some implementations, one or more of: one or more object classification models, e.g. a model for classifying one or more objects in the image into one of a plurality of classes; one or more image captioning models, e.g. a model that takes an image as input and generates a natural language description of contents of the image; one or more object detection models, e.g. a model that splits a single image into sub-images that form semantic units; one or more optical character recognition models, e.g. models that can extract text from images; and/or one or more entity recognition models, e.g. models that detect and label image data with unique identifiers from a knowledge base.

The prompt 222 is input into one or more LLMs 224. The one or more LLMs 224 generate a natural language response 226 given all structured signals (i.e., the contextual information comprising the outputs of the multimodal models 218 and/or the unimodal models 232), the conversation history (if present) and the current query 208, 212.

The response 226 is then rendered at the user application 206, e.g. as text in a text-based dialogue/chat application, converted to speech using a text-to-speech engine or the like.

In some examples, addition of extra context that the Conversation LLM 224 has never seen when trained can lead to undesired responses from the LLM 224. The LLM 224 may, for example, disregard the extra context or generate responses that don't take it into account. Such issues are solved by performing LLM fine-tuning. For example, a set of golden tuples (image signals, user query, desired response) is collected, either manually or automatically, e.g., by filtering automatic responses that match certain quality criteria. Once a threshold number of such tuples has been collected, the LLM 224 can be fine-tuned, i.e., at least some of the weights are recalibrated to make it more likely to output the desired responses when it is exposed to the provided image signals.

Turning now to FIG. 3, FIG. 3 illustrates an overview of an example method for responding to an image query. The method may be performed by one or more computer systems, such as the system described herein in relation to FIG. 6. The method may be combined with the method of FIG. 2. Alternatively, the method may be performed individually.

A computer system, such as a backend server 302 (such as the NL based response system 120 described herein in relation to FIG. 1), receives an input query 304 comprising an input image and, in some examples, an input natural language query that refers to the input image from a user application 306 running on a client device (such as client device 110 described herein in relation to FIG. 1). Based on the input image, the backend server 302 generates one or more image search requests 334 for one or more search engines 336. The one or more search engines 336 are invoked using the one or more image search requests 334, and return one or more web resources in response. Each of the returned web resources contains at least one image that is responsive to the image search request, e.g., contains at least one image that is related to the input image. A text extraction engine 340 extracts one or more text extracts 340 from the one or more web resources, e.g. image captions, website text or the like. The extracted text 340 is used by a prompt preparation 320 engine to generate one or more prompts 322 for one or more LLMs 324. The one or more LLMs 324 process the generated prompts 322 to generate one or more responses 326 to the input query. One or more of the responses 226 are output to a user via the user application 306 on the client device.

As an example, the computer system may receive an image of an actor and the text “what is she in?”.

The search request 334 comprises a request for one or more search engines 336 to find one or more web resources that contain one or more images that are similar to the input image, e.g., contain the same or similar entity or entities, relate to the same subject matter, are in the same style or the like (referred to herein as “relevant images”). In some implementations, the search request 334 is a reverse image search.

Responsive to the search request, the one or more search engines 336 return one or more web resources that each contain at least one of one or more images found in response to the search request 334, i.e., each contain one or more relevant images. For example, the web resources may comprise one or more webpages, one or more further web images, or the like.

The computer system performs text extraction 338 on the web resources to generate one or more text extracts 340. In some implementations, one or more of the text extracts 340 contain all of the text from at least one of the web resources (referred to herein as a “full text extract”), e.g., all the text on one or more webpages containing a relevant image, or all of the text of a caption of one or more web images. In some implementations, one or more of the text extracts 340 are a proper subset of the text of a web resource (referred to herein as a “partial text extract”). The text extracts 340, in some examples, comprise full text extracts from a first set of web resources and partial text extracts from a second set of web resources. The first set of web resources are, for example, web resources containing a total amount of text below a threshold size, with the second set of text resources containing a total amount of text above a threshold size.

Returning to the example of the actor, the one or more search engines return one or more web pages, each containing one or more respective pictures of the actor, e.g., news articles, reviews, encyclopedia articles, fan websites or the like.

The one or more text extracts 340 are provided to the prompt preparation engine 320 as context for the LLM prompt. The prompt preparation engine 320 generates a prompt 322 for the one or more LLMs 324 based on one or more of the text extracts 340 and, if present, the input query and/or conversation history. In some implementations, the prompt preparation engine 320 uses a static schema to generate the prompt parts from the text extracts 340. For example, the prompt preparation engine 320 appends each text extract 340 being used to a predefined string, e.g. “Context: [text extract]”, or “The following text relates to the input image:”.

As an example, in the example of the actor, the prompt 322 generated by the prompt preparation engine 320 may be of the form (where the text extracts are shown schematically for conciseness):
“Please reply in a polite and helpful manner.
Context: [text extract][text from web resource 1]
Context: [text extract][text from web resource 2]
Context: [text extract][text from web resource 3]
Query: what is she in?”

The prompt 322 is input into one or more LLMs 324. The one or more LLMs 324 generate a natural language response given all structured signals (i.e., the contextual information comprising the text extracts 340), the conversation history (if present) and the current query 308, 312 (in either explicit form or as input).

The response 326 is rendered at the user application 306, e.g. as text in a text-based dialogue/chat application, converted to speech using a text-to-speech engine or the like.

In some implementations, the method of FIG. 3 is combined with the method of FIG. 2, i.e. the input to the prompt preparation engine 220, 320 comprises natural language descriptors 218 output by the multimodal image processing models 216 and the text extracts 340 extracted from the web resources returned by the search engine 340 (and, optionally, the output of the unimodal image models 228, 328). In some examples, the text extracts 340 are used as input into the explication model 310 to assist in explicating the input query. For example, the input text “what is she in” may be explicated by the explication model 310 to “what films is X in” (where X is the actor identity) based on, e.g., the conversation history, the text extracts 340 and/or the output of one or more unimodal models 330.

Turning now to FIG. 4 a flowchart is depicted that illustrates an example method 400 of responding to a multimodal query. The method 400 corresponds to the method 200 described in relation to FIG. 2. For convenience, the operations of the method 400 are described with reference to a system that performs the operations. This system of the method 400 includes one or more processors, memory, and/or other component(s) of computing device(s) (e.g., the NL-based response system 120 of FIG. 1). Moreover, while operations of the method 400 are shown in a particular order, this is not meant to be limiting. One or more operations may be reordered, omitted, and/or added.

At block 452, the system receives a query. The query comprises an input image and an input text query that refers to the input image and comprises one or more implicit queries. The query can be one formulated based on user interface input at a client device, such as typed input, voice input, input to cause an image to be captured or selected, etc. The text query can be, for example, a voice query, a typed query, or an inferred/parameterless query. In some implementations, when the query includes content that is not in textual format, the system can convert the query to a textual format or other format. For example, if the query is a voice query the system can perform automatic speech recognition (ASR) to convert the voice query into textual format.

The query can alternatively be an implied query, such as one formulated and/or submitted independent of any user input directed to formulating the implied query. For example, the query can be an implied query that is automatically generated based on profile data and that is automatically submitted. For instance, the implied query can be “machine learning”, based on profile data indicating interest in machine learning topic(s). As another example, the query can be an implied query that is automatically generated and/or automatically submitted based on a current and/or recent context. As yet another example, the query can be an implied query that is submitted based on the user providing some indication of a desire to perform a search (e.g., pushing a search button, performing a search touch gesture, accessing a particular screen or state of an application), but that is generated automatically based on content currently being displayed at a client device, location, time of day, and/or other context signal(s).

As an example, a user inputs an image of a cat wearing sunglasses sitting on a chair in front of a swimming pool and a text query “what is it wearing?”.

In some implementations, the input image is processed by one or more unimodal image models (i.e. models that an image as input, but not text) to generate one or more query-independent properties of the input image (i.e., image properties that are agnostic to the input text query). Such properties include, for example, one or more of: one or more identities of objects/entities in the image; a caption for the image; one or more text extracts extracted from the image; and/or a classification of the image. The one or more unimodal image models comprise, for example, one or more of: an object detection model; an entity recognition model; a captioning model; an optical character recognition model; and/or an image segmentation model.

Returning to the example of the cat, the image is input into an objection/entity detection model, which outputs a plurality of objects/entities present in the image, e.g. “cat”, “sunglasses”, “chair”, and “swimming pool”.

At block 454, the system generates one or more explicit text queries using an explication model that explicate the one or more implicit queries in the text query of the input. The explication model takes as input the input text query, and processes it based on values of parameters of the explication model to generated explicit versions of implicit queries in the text query. The explication model, in some examples, takes input further input based on the output of the unimodal image models, e.g. a natural language description of the output of the unimodal image models. The output of the unimodal models is, in some examples, combined with one or more predefined natural language strings that describe the type of output of the unimodal models, e.g. appended or used to fill one or more slots in the natural language string. For example, an image caption output of an image captioning model can be appended to the string “The image shows:” or “[caption:]”, an entity identified in the image can be appended the string “The image contains the entity” or “[entity:]”, text extracted from the image can be appended the string “The image contains the text” or “[text extract:]”, etc.

In some implementations, the explication model is an LLM. The explication model, for example, comprises the same LLM that is used to generate a response to the query in block 460. Alternatively, the explication model is a auxiliary LLM, i.e. a specialized explication LLM that has been trained/fine-tuned to explicate implicit queries.

Returning to the example of the cat wearing sunglasses, the input to the explication model may be “Explicate the following query: Context: The image contains [entity] cat, [entity] sunglasses, [entity] chair, [entity] swimming pool; User: what is it wearing?”. The explication model processes this input, and outputs the explicit query “What is the cat wearing?”.

At block 456, the system processes input image and the one or more explicit queries using one or more multi-modal image models process the to generate one or more natural language descriptors (e.g. a text description) of properties of the input image that are responsive to the one or more explicit queries. The one or more multimodal image models may comprise a visual query answering (VQA) model.

Returning to the example of the cat wearing sunglasses, the input to a multi-modal image model is, for example, the text “What is the cat wearing?” and the input image. The corresponding output from the multi-modal image model is, for example, “sunglasses”.

At block 458, the system generates one or more input prompts for one or more LLMs based on the explicit text query and/or the input text query, and the natural language descriptors output by the multi-modal image models. The output of the unimodal model may also be used to generate the input prompt. Generating the input prompt for the LLM comprise using a static schema, such as completing one or more pre-defined strings using the one or more natural language descriptors and/or the output of the unimodal models.

At block 460, the system generates a response to the input query based on the input prompt using the LLM. The LLM processes the input query to generate a natural language (e.g., text) response, and outputs the response.

At block 462, the system causes the response to the input prompt to be rendered at the client device. For example, the system can cause the response to be rendered graphically in an interface of an application of a client device via which the query was submitted. As another example, the system can additionally or alternatively cause the response to be audibly rendered via speaker(s) of a client device via which the query was submitted. The response can be transmitted from the system to the client device, if the system is remote from the client device.

Turning now to FIG. 5 a flowchart is depicted that illustrates an example method 500 of responding to an image-based query. The method 500 corresponds to the method 300 described in relation to FIG. 3. For convenience, the operations of the method 500 are described with reference to a system that performs the operations. This system of the method 500 includes one or more processors, memory, and/or other component(s) of computing device(s) (e.g., the NL-based response system 120 of FIG. 1). Moreover, while operations of the method 500 are shown in a particular order, this is not meant to be limiting. One or more operations may be reordered, omitted, and/or added. One or more of the operations may be performed alongside or in addition to operations of FIG. 4, e.g. in parallel or in sequence.

At block 552, the system receives a query. The query comprises an input image and, in some examples, an input text query that refers to the input image (either implicitly or explicitly). Block 552 may, for example, correspond to block 452 of FIG. 4.

At block 554, the system generates an image search request for a search engine based on the input image. The search request is, in some examples, comprises a request for similar images to the input image. In some examples, the image search request is a reverse image search request. The search request is, in some examples, further based on the input query, e.g. contains the input query, an explication of the input query, outputs of one or more unimodal image processing models and/or natural language descriptors from one or more multimodal image processing models.

At block 556, the system transmits the image search request to one or more search engines. The one or more search engines perform an image search based on the search request and return one or more web resources that each contain a relevant image, i.e. contain at least one of one or more images responsive to the search request.

At block 558, the system receives, in response to the search request, a search response comprising the one or more web resources that contain at least one of one or more images responsive to the image search request. The one or more web resources may comprise, for example, web pages, web images, social media pages or the like.

At block 560, the system extracts one or more text extracts from the one or more web resources. The extracted text may comprise text of one or more webpages in which images responsive to the image search request are incorporated; text of one or more captions of images responsive to the image search request; one or more tags of images responsive to the image search request; and/or one or more sets of metadata of images responsive to the image search request.

At block 562, the system generates a prompt for an LLM based on the one or more text extracts. Generating the prompt comprises, in some examples, using a static schema to transform the text extracts into prompt parts. For example, the text extracts are appended to one or more predefined strings indicating that the following text is a text extract from a web resource.

At block 564, a response to the input query is generated by the LLM based on the input prompt. The LLM processes the input query to generate a natural language (e.g., text) response, and outputs the response.

At block 566, the system causes the response to the input prompt to be rendered at the client device. For example, the system can cause the response to be rendered graphically in an interface of an application of a client device via which the query was submitted. As another example, the system can additionally or alternatively cause the response to be audibly rendered via speaker(s) of a client device via which the query was submitted.

Turning now to FIG. 6, a block diagram of an example computing device 610 that may optionally be utilized to perform one or more aspects of techniques described herein is depicted. In some implementations, one or more of a client device, cloud-based automated assistant component(s), and/or other component(s) may comprise one or more components of the example computing device 610.

Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of the methods disclosed herein, as well as to implement various components depicted in FIG. 1.

These software modules are generally executed by processor 614 alone or in combination with other processors. Memory 625 used in the storage subsystem 624 can include a number of memories including a main random access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 814.

Bus subsystem 612 provides a mechanism for letting the various components and subsystems of computing device 610 communicate with each other as intended. Although bus subsystem 612 is shown schematically as a single bus, alternative implementations of the bus subsystem 612 may use multiple busses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

Some implementations disclosed are directed to a method, implemented by processor(s), that includes receiving an input query associated with a client device. The input query includes an input image and an input text query. The input text query refers to the input image and includes one or more implicit queries. The method further includes generating, using an explication model and based on the input text query, one or more explicit text queries that explicate one or more of the implicit queries in the input text query. The method further includes processing, using a multi-modal image processing model, the input image and the one or more explicit text queries to generate one or more natural language descriptors. The one or more natural language descriptors are descriptive of one or more properties of the input image, and the one or more natural language descriptors are responsive to the one or more explicit text queries. The method further includes generating, based on the one or more natural language descriptors and the input text query and/or the one or more explicit text queries, an input prompt for a large language model, LLM. The method further includes generating, from the input prompt and using the LLM, a response to the input query, and causing the response to the input query to be rendered at the client device.

These and other implementations of the technology disclosed herein can include one or more of the following features.

In some implementations, the multi-modal image processing model is a visual query answering model.

In some implementations, generating the input prompt for the LLM includes completing one or more pre-defined strings using the one or more natural language descriptors.

In some implementations, the method further includes processing, using one or more unimodal image processing models, the input image to generate one or more query independent properties of the input image. In those implementations, generating the input prompt for the LLM is further based on the one or more one or more query independent properties of the input image. In some versions of those implementations, generating the one or more explicit text queries further includes processing, using the explication model, the one or more query independent properties of the input image. In some additional or alternative versions of those implementations, generating the input prompt for the LLM includes completing one or more pre-defined string using the one or more query independent properties of the input image. The one or more unimodal image processing models can include, for example: an object detection model; an entity recognition model; a captioning model; an optical character recognition model; and/or an image segmentation model.

In some implementations, the input prompt for the LLM includes contextual information indicative of contents of the image, wherein the contextual information is based on the one or more natural language descriptors.

In some implementations, the method further includes: generating, based on the input image, a search request for a search engine; transmitting, to the search engine, the search request; and receiving, from the search engine and in response to the search request, a search response. In some versions of those implementations, generating the input prompt for the LLM is further based on the search response. In some of those versions, the search request is based on the one or more natural language descriptors and/or the one or more explicit text queries. In some additional or alternative versions, the search response includes one or more text extracts associated with one or more images returned by the search engine in response to the search request. In some additional or alternative versions, the search request is an image search request requesting similar images to the input image and the search response includes text from one or more resources in which at least one of the images responsive to the image search request are incorporated. For example, the search response can include the one or more resources in which the images responsive to the image search request are incorporated, and the method can further include extracting the text from the one or more resources in which at least one of the images responsive to the image search request are incorporated. For instance, the text from the one or more resources in which at least one of the images responsive to the image search request are incorporated can include: text of one or more webpages in which at least one of the images responsive to the image search request are incorporated; text of one or more captions of at least one of the images responsive to the image search request; one or more tags of at least one of the images responsive to the image search request; and/or one or more sets of metadata of at least one of the images responsive to the image search request.

In some implementations, the method further includes receiving a conversation history that includes a summary of previous user interactions with the client device, and generating the one or more explicit text queries is further based on the conversation history.

In some implementations, the explication model includes the LLM or a further LLM.

Some implementations disclosed are directed to a method, implemented by processor(s), that includes receiving an input query, associated with a client device, that includes an input image. The method further includes generating, based on the input image, an image search request for a search engine. The method further includes transmitting, to the search engine, the image search request. The method further includes receiving, from the search engine and in response to the image search request, a search response including one or more web resources containing at least one of one or more images responsive to the image search request. The method further includes extracting one or more text extracts from the one or more web resources. The method further includes generating, based on the one or more text extracts, an input prompt for a large language model, LLM. The method further includes generating, from the input prompt and using the LLM, a response to the input query. The method further includes causing the response to the input query to be rendered at a client device.

These and other implementations of the technology disclosed herein can include one or more of the following features.

In some implementations, the one or more text extracts from the one or more web resources in which one or more of the images responsive to the image search request are incorporated includes: text of one or more webpages in which at least one of the images responsive to the image search request are incorporated; text of one or more captions of at least one of the images responsive to the image search request; one or more tags of at least one of the images responsive to the image search request; and/or one or more sets of metadata at least one of the images responsive to the image search request.

In some implementations, the input query further includes an input text query and the search request and/or the input prompt is further based on the input text query.

In some implementations, the method further includes processing, using one or more unimodal image processing models, the input image to generate one or more query independent properties of the input image. In some versions of those implementations, generating the image search request for a search engine and/or generating the input prompt for the LLM is further based on the one or more one or more query independent properties of the input image. In some of those versions, the one or more unimodal image processing models can include, for example: an object detection model; an entity recognition model; a captioning model; an optical character recognition model; and/or an image segmentation model.

Other implementations can include one or more computer readable media (transitory and/or non-transitory) including instructions executable by one or more processors (e.g., central processing unit(s) (CPU(s)), graphics processing unit(s) (GPU(s)), and/or tensor processing unit(s) (TPU(s)) to perform a method such as one or more of the methods described above and/or elsewhere herein. Yet other implementations can include a client device having at least one microphone, at least one display, and one or more processors operable to execute stored instructions to perform a method such as one or more of the methods described above and/or elsewhere herein.

What is claimed is:

1. A method implemented by one or more processors, the method comprising:
receiving an input query associated with a client device, the input query comprising an input image and an input text query, wherein the input text query refers to the input image and comprises one or more implicit queries;
generating, using an explication model and based on the input text query, one or more explicit text queries that explicate one or more of the implicit queries in the input text query;
processing, using a multi-modal image processing model, the input image and the one or more explicit text queries to generate one or more natural language descriptors, the one or more natural language descriptors descriptive of one or more properties of the input image, wherein the one or more natural language descriptors are responsive to the one or more explicit text queries;
generating, based on the one or more natural language descriptors and the input text query and/or the one or more explicit text queries, an input prompt for a large language model, LLM;
generating, from the input prompt and using the LLM, a response to the input query; and
causing the response to the input query to be rendered at the client device.

2. The method of claim 1, wherein the multi-modal image processing model is a visual query answering model.

3. The method of claim 1, wherein generating the input prompt for the LLM comprises:
completing one or more pre-defined strings using the one or more natural language descriptors.

4. The method of claim 1, wherein the method further comprises:
processing, using one or more unimodal image processing models, the input image to generate one or more query independent properties of the input image,
wherein generating the input prompt for the LLM is further based on the one or more one or more query independent properties of the input image.

5. The method of claim 4, wherein generating the one or more explicit text queries further comprises:
processing, using the explication model, the one or more query independent properties of the input image.

6. The method of claim 4, wherein generating the input prompt for the LLM comprises:
completing one or more pre-defined string using the one or more query independent properties of the input image.

7. The method of claim 4, wherein the one or more unimodal image processing models comprises: an object detection model; an entity recognition model; a captioning model; an optical character recognition model; and/or an image segmentation model.

8. The method of claim 1, wherein the input prompt for the LLM comprises contextual information indicative of contents of the image, wherein the contextual information is based on the one or more natural language descriptors.

9. The method of claim 1, further comprising:
generating, based on the input image, a search request for a search engine;
transmitting, to the search engine, the search request;
receiving, from the search engine and in response to the search request, a search response,
wherein generating the input prompt for the LLM is further based on the search response.

10. The method of claim 9, wherein the search request is based on the one or more natural language descriptors and/or the one or more explicit text queries.

11. The method of claim 9, wherein the search response comprises one or more text extracts associated with one or more images returned by the search engine in response to the search request.

12. The method of claim 9, wherein:
the search request is an image search request requesting similar images to the input image; and
the search response comprises text from one or more resources in which at least one of the images responsive to the image search request are incorporated.

13. The method of claim 12, wherein:
the search response comprises the one or more resources in which the images responsive to the image search request are incorporated; and
the method further comprises extracting the text from the one or more resources in which at least one of the images responsive to the image search request are incorporated.

14. The method of claim 12, wherein the text from the one or more resources in which at least one of the images responsive to the image search request are incorporated comprises:
text of one or more webpages in which at least one of the images responsive to the image search request are incorporated;
text of one or more captions of at least one of the images responsive to the image search request;
one or more tags of at least one of the images responsive to the image search request;
and/or one or more sets of metadata of at least one of the images responsive to the image search request.

15. The method of claim 1, further comprising:
receiving a conversation history comprising a summary of previous user interactions with the client device,
wherein generating the one or more explicit text queries is further based on the conversation history.

16. The method of claim 1, wherein the explication model comprises the LLM or a further LLM.

17. A method implemented by one or more processors, the method comprising:
receiving an input query associated with a client device, the input query comprising an input image;
generating, based on the input image, an image search request for a search engine;
transmitting, to the search engine, the image search request;
receiving, from the search engine and in response to the image search request, a search response comprising one or more web resources containing at least one of one or more images responsive to the image search request;
extracting one or more text extracts from the one or more web resources;
generating, based on the one or more text extracts, an input prompt for a large language model, LLM;
generating, from the input prompt and using the LLM, a response to the input query; and
causing the response to the input query to be rendered at a client device.

18. The method of claim 17, wherein the one or more text extracts from the one or more web resources in which one or more of the images responsive to the image search request are incorporated comprises:
text of one or more webpages in which at least one of the images responsive to the image search request are incorporated;
text of one or more captions of at least one of the images responsive to the image search request;
one or more tags of at least one of the images responsive to the image search request; and/or
one or more sets of metadata at least one of the images responsive to the image search request.

19. The method of claim 17, wherein:
the input query further comprises an input text query; and
the search request and/or the input prompt is further based on the input text query.

20. The method of claim 17, wherein the method further comprises:
processing, using one or more unimodal image processing models, the input image to generate one or more query independent properties of the input image,
wherein generating the image search request for a search engine and/or generating the input prompt for the LLM is further based on the one or more one or more query independent properties of the input image.

21. The method of claim 20, wherein the one or more unimodal image processing models comprises: an object detection model; an entity recognition model; a captioning model; an optical character recognition model; and/or an image segmentation model.
